(19) United States
(12) Patent Application Publication
(10) Pub. No.: US 2016/0027533 A1
(43) Pub. Date: Jan. 28, 2016

(54) METHOD OF FORMING STABLE STATES OF DENSE HIGH-TEMPERATURE PLASMA

(71) Applicant: ZAKRYTOE AKTISIONERNOE OBSCHESTVO RUSTERMOSINTEZ, Moscow (RU)

(72) Inventors: Stanislav Ivanovich FISSENKO, Moscow (RU); Igor Stanislavovich Fissenko, Moscow (RU)

(21) Appl. No.: 14/316,387

(22) Filed: Jun. 26, 2014

Related U.S. Application Data
(63) Continuation-in-part of application No. 12/270,123, filed on Nov. 13, 2008, now abandoned.
Application No. 12/270,123 is a continuation-in-part of application No. 10/570,857, filed on Mar. 7, 2006, now abandoned.

(30) Foreign Application Priority Data
Nov. 30, 2004 (RU) 2004135022

(51) Int. Cl. G21B 1/11

(52) U.S. Cl. CPC G21B 1/11

(57) ABSTRACT

A method is proposed for forming stable states of a dense high-temperature plasma, including plasmas for controlled fusion, the method comprising: generating a dense high-temperature plasma in pulsed heavy-current discharges, followed by injecting the plasma from the area of a magnetic field with parameters corresponding to the conditions of gravitational emission of electrons with a banded energy spectrum and subsequent energy transfer along the spectrum (cascade transition) into the long wavelength region (of eV-energy), this leading to the state of locking and amplification of the gravitational emission in the plasma with simultaneous compression thereof to the states of hydrostatic equilibrium, with using multielectron atoms as a prerequisite element in the composition of a working gas, for quenching the spontaneous gravitational emission from the ground energy levels (the keV-region) of the electron in the proper gravitational field.

### CROSS-REFERENCE TO RELATED APPLICATIONS

This application is a continuation-in-part of application Ser. No. 12/270,123 filed on Nov. 13, 2008, which is a continuation-in-part of application Ser. No. 10/570,857 filed on Mar. 7, 2006 which is an application under 35 U.S.C. 371 of International Application No. PCT/RU2005/000284 filed on May 24, 2005, the entire contents of which are incorporated herein by reference.

### FIELD OF THE ART

The present invention relates to a method of forming stable states of a dense high-temperature plasma which can be used, for example, for controlled fusion.

### STATE OF THE ART

The existing state of the art related to the realization of stable states of a dense high-temperature plasma applicable for the purposes of nuclear fusion can be defined as a stage of the formation and confinement of a plasma by a magnetic field in devices which make it possible to realize separate techniques of the claimed method but not the method as such, i.e., a method of achieving a stable state of a dense high-temperature plasma. In this respect the claimed method has no close analogs.

From the state of the art a heavy-current pulsed discharge is known, which is shaped with the aid of a cylindrical discharge chamber (whose end faces function as electrodes) which is filled with a working gas (deuterium, hydrogen, a deuterium-tritium mixture at a pressure of 0.5 to 0 mm Hg, or noble gases at a pressure of 0.01 to 0.1 mm Hg). Then a discharge of a powerful capacitor battery is effected through the gas, with the voltage of 20 to 40 kV supplied to the anode and the current in the forming discharge reaching about 1 MA. In experiments (Lukyanov S.Yu. “Hot Plasma and Controlled Fusion”, Moscow, Atomizdat, 1975 (in Russian)) first a first phase of the process was observed—plasma compression to the axis by the current magnetic field with decrease of the current channel diameter by approximately a factor of 10 and formation a brightly glowing plasma column on the discharge axis (z-pinch). In the second phase of the process a rapid development of current channel instabilities (kinks, helical disturbances, etc.) were observed.

The buildup of these instabilities occurs very rapidly and leads to the degradation of the plasma column (plasma jets outburst, discharge discontinuities, etc.), so that the discharge lifetime is limited to a value on the order of 10⁻⁶ s. For this reason in a linear pinch it turns out to be unreal to fulfill the conditions of nuclear fusion defined by the Lawson criterion nτ>10¹⁴ cm⁻³s, where n is the plasma concentration, τ is the discharge lifetime.

A similar situation takes place in a Θ-pinch, when to a cylindrical discharge chamber an external longitudinal magnetic field inducing an azimuthal current is impressed.

Magnetic traps are known, which are capable of confining a high-temperature plasma for a long time (but not sufficient for nuclear fusion to proceed) within a limited volume (see Artsimovich L. A., “Closed Plasma Configurations”, Moscow, Atomizdat, 1969 (in Russian)). There exist two main varieties of magnetic traps: closed and open ones.

Magnetic traps are devices which are capable of confining a high-temperature plasma for a sufficiently long time within a limited volume and which are described in Artsimovich L. A., “Closed Plasma Configurations”, Moscow, Atomizdat, 1969.

To magnetic traps of closed type (on which hopes to realize the conditions of controlled nuclear fusion (CNU) were pinned for a long time) there belong devices of the Tokamak, Spheromak and Stellarator type in various modifications (Lukyanov S. Yu., “Hot Plasma and CNU”, Moscow, Atomizdat, 1975 (in Russian)).

In devices of the Tokamak type a ring current creating a rotary transformation of magnetic lines of force is excited in the very plasma. Spheromak represents a compact torus with a toroidal magnetic field inside a plasma. Rotary transformation of magnetic lines of force, effected without exciting a toroidal current in plasma, is realized in Stellarators (Volkov E. D. et al., “Stellarator”, Moscow, Nauka, 1983 (in Russian)).

Open-type magnetic traps with a linear geometry are: a magnetic bottle, an ambipolar trap, a gas-dynamic type trap (Ryutov D. D., “Open traps”, Uspekhi Fizicheskikh Nauk, 1988, vol. 154, p. 565).

In spite of all the design differences of the open-type and closed-type traps, they are based on one principle: attaining hydrostatic equilibrium states of plasma in a magnetic field through the equality of the gas-kinetic plasma pressure and of the magnetic field pressure at the external boundary of plasma. The very diversity of these traps stems from the absence of positive results.

When using a plasma focus device (PF) (this is how an electric discharge is called), a non-stationary bunch of a dense high-temperature (as a rule, deuterium) plasma is obtained (this bunch is also called “plasma focus”). PF belongs to the category of pinches and is formed in the area of current sheath cumulation on the axis of a discharge chamber having a special design. As a result, in contradistinction to a direct pinch, plasma focus acquires a non-cylindrical shape (Petrov D. P. et al., “Powerfu) pulsed gas discharge in chambers with conducting walls” in Collection of Papers “Plasma Physics and Problem of Controlled Thermonuclear Reactions”, volume 4, Moscow, lzdatel'stvo AN SSSR, 1958 (in Russian)).

Unlike linear pinch devices, where the function of electrodes is performed by the chamber end faces, in the PF the role of the cathode is played by the chamber body, as a result of which the plasma bunch acquires the form of a funnel (thence the name of the device). With the same working parameters as in the cylindrical pinch, in a PF device a plasma having higher temperature, density and longer lifetime is obtainable, but the subsequent development of the instability destroys the discharge, as is the case in the linear pinch (Burtsev B. A. et al., “High-temperature plasma formations” in: ltogi Nauki i Tekhniki”, “Plasma Physics” Series, vol. 2, Moscow, lzdatel'stvo AN SSSR, 1981 (in Russian)), and stable states of plasma are actually not attained.

Non-stationary bunches of high-temperature plasma are also obtained in gas-discharge chambers with a coaxial arrangement of electrodes (using devices with coaxial plasma injectors). The first device of such kind was commissioned in 1961 by J. Mather (Mather J. W., “Formation on the high-density deuterium plasma focus”, Phys. Fluids, 1965, vol, 8, p. 366). This device was developed further (in particular, see (J. Brzosko et al., Phys. Let. A., 192 (1994), p. 250, Phys. Let. A., 155 (1991), p. 162)). An essential element of this development was the use of a working gas doped with multielectron atoms. Injection of plasma in such devices is attained owing to the coaxial arrangement of cylindrical chambers, wherein the internal chamber functioning as the anode is disposed geometrically lower than the external cylinder—the cathode. In the works of J. Brzosko it was pointed out that the efficiency of the generation of plasma bunches increases when hydrogen is doped with multielectron atoms. However, in these devices the development of the instability substantially limits the plasma lifetime as well. As a result, this lifetime is smaller than necessary for attaining the conditions [bra stable course of the nuclear fusion reaction. With definite design features, in particular, with the use of conical coaxial electrodes (M. P. Kozlov and A. I. Morozov (Eds.), “Plasma Accelerators and Ion Guns”, Moscow, Nauka, 1984 (in Russian)), such devices are already plasma injection devices. In the above-indicated devices (devices with coaxial cylindrical electrodes) plasma in all the stages up to the plasma decay, remains in the magnetic field area, though injection of plasma into the interelectrode space takes place. In pure form injection of plasma from the interelectrode space is observed in devices with conical coaxial electrodes. The field of application of plasma injectors is regarded to be auxiliary for plasma injection with subsequent use thereof (for example, for additional pumping of power in devices of Tokamak type, in laser devices, etc.), which, in turn, has limited the use of these devices not in the pulsed mode, but in the quasi-stationary mode.

Thus, the existing state of the art, based on plasma confinement by a magnetic field, does not solve the problem of confining a dense high-temperature plasma during a period of time required for nuclear fusion reactions to proceed, but effectively solves the problem of heating plasma to a state in which these reactions can proceed.

### DISCLOSURE OF THE INVENTION

The author proposes a solution of the above-stated problem, which can be attained by a new combination of means (devices) known in the art with the use of their combination (the parameters considered earlier), which was not only not used heretofore, but proposed or supposed in the state of the art, and which is further described in detail in the sections dealing with carrying the invention into effect and in the set of claims.

Accordingly, the present invention relates to a method of forming stable states of a dense high-temperature plasma, which comprises the following steps:

a) generation of a dense high-temperature plasma from hydrogen and isotopes thereof with the aid of pulsed heavy-current discharges;

b) injection of the plasma from the area of a magnetic field with parameters corresponding to the conditions of gravitational emission of electrons with a banded energy spectrum;

c) energy transfer along the spectrum.

The energy transfer (step c) is performed by cascade transition into the long wavelength region of eV-energy to the state of locking and amplification of the gravitational emission and simultaneous compression to the states of hydrostatic equilibrium, and in the formation of said states in the composition of a working gas multielectron atoms are used for quenching the spontaneous gravitational emission from the ground energy levels of the key-region electron in the proper gravitational field.

It is preferable that in one of the embodiment of the invention for obtaining stable states of a dense high-temperature plasma use is made of hydrogen and multielectron atoms, such as krypton, xenon, and other allied elements (neon, argon).

In another preferable embodiment of the invention in order to realize the conditions for the nuclear fusion reaction to proceed use is made of hydrogen and carbon, wherein carbon is also employed both for quenching the spectra of gravitational emission with keV energies and as a fusion reaction catalyst.

The claimed method provides a scheme for forming stable states of a dense high-temperature plasma, which scheme comprises a device for supplying a working gas, a discharge chamber, a discharge circuit, a chamber for forming a stable plasma bunch.

If and when necessary, each of the cited blocks of the scheme can be fitted with appropriate measuring equipment.

The invention is illustrated by a circuit diagram of a pulsed heavy-current magnetic-compression discharge on multiply charged ions with conical coaxial electrodes(FIG. 1), in which:

1. a fast-acting valve for supplying a working gas (1) into a gap between an internal electrode (2) and an external electrode (3);

2. an external electrode;

3. an internal electrode has a narrowing surface close to conical one;

4. a diverter channel which prevents the entrance of admixtures into the compression area;

5. a discharge circuit;

6. an area of compression by a magnetic field;

7. an area of compression due to efflux current in the outgoing plasma jet and subsequent compression by the emitted gravitational field.

### BRIEF DESCRIPTION OF THE DRAWINGS

FIG. 1 is a circuit diagram of a pulsed heavy-current magnetic-compression discharge on multiply charged ions with conical coaxial electrodes.

FIG. 2 is a diagram showing transitions to stationary states of electrons in proper gravitational field.

FIG. 3 is an image showing an electron in a proper gravitational field in the ground stationary state, wherein rᵢ is the radius of irremovable curvature, and r₀ is the “classical” electron radius being a radius of the ground stationary state of an electron in a proper gravitational field.

FIG. 4 is a diagram showing Graviton emission when quenching an electron in a nucleus.

FIG. 5, which includes FIGS. 5(a) and 5(b), are diagrams showing quenching lower excited states of electron by: a) many-electron ions (a photoelectric effect with release of one electron or autoionization (Auger effect) with release of two electrons depending on the ion number and quenching energy); b) nuclei without electron shells when an excited electron returns to normal state transferring excess energy directly to the nucleus with higher probability for the lover energy levels of excited electrons.

FIG. 6 is a graph showing a measured Fe He-δ line at 8.488 keV (broken curve) compared to calculation (smooth curve), M. G. Haines et al., PRL, 96, 075003 (2006).

FIG. 7, which includes FIGS. 7(a) and 7(b), are graphs showing experimental (a) and calculated (b) parts of a micropinch spectrum normalized for line Lyβ intensity in the area of the basic state ionization threshold of He-like ions. The firm line in variant (b) corresponds to density of 0.1g/cm³, and the dotted line to 0.01 g/cm³; it was assumed that Tₑ₌0.35 keV, [V. Yu. Politov, Proceedings of International Conference “Zababakhin Scientific Proceedings”, 1998].

FIG. 8 is a graph showing electron energy spectra: 1—after passing the grid, 2—after passing the Al foil 13 μm thick; 3—spectrum calculation according to ELIZA program based on the database [D. E. Cullen et al., Report IAEA-NDS-158, Sep., 1994] for each spectrum 1. The spectrum is normalized by the standard.

FIG. 9 is a graph showing the difference of spectral density for theoretical and experimental spectra of electrons passed through Ti, Ta, and Al foils.

FIG. 10 is a graph showing a part of the vacuum sparkle spectrum and a corresponding part of the solar flare spectrum. [E. Ya. Goltz et al., DAN USSR, Ser. Phys., 1975, V. 220, p. 560].

FIG. 11 is a graph showing (top) the MOS-camera spectrum in the range of 3 to 4 keV, XMM-Newton observatory. Separate dashes are the results of observation with errors; the red curve is the best reproduction of the spectrum when only known emission lines of ions taken into account; the blue curve is the result of addition of another previously unknown emission line. The bottom shows the deviation of observation data from the red and blue curves, E. Bulbul et al. Detection of An Unidentified Emission Line in the Stacked X-ray spectrum of Galaxy Clusters // e-print arXiv:1402.2301 [astro-ph.CO].

FIG. 12, which includes FIG. 12(a) and FIG. 12(b), is a graph showing the X-ray spectrum of the central part of the Andromeda nebula according to the results of observation with a MOS-camera of XMM-Newton observatory . FIG. 12(a): the entire spectrum from 1 to 8 keV; FIG. 12(b): the range of 3 to 4 keV. Symbols are the same as in FIG. 11 A. Boyarsky, 0. Ruchayskiy, D. lakubovskyi, J. Franse. An unidentified line in X-ray spectra of the Andromeda galaxy and Perseus galaxy cluster // [symbol] arXiv:1402.4119 [astro-ph.CO].

FIG. 13 is a graph showing X-ray spectra of various X-ray sources: supersoft source, stellar corona, and the classical source , Kahabka P. and van den Heuvel E. P. J., 1997, Ann. Rev. Astron. Astrophys., 35, 69

FIG. 14 illustrates a scheme of K-, L- and M-levels of energy of the atom, and the main lines of K- and L- series; n, I, j are the principal, the orbital and the inner quantum numbers of energy levels K, L₁, L₂ etc. The energies of photons of the main lines reach units and scores of keV.

FIG. 15 is an outline drawing of the discharge chamber (MAGO chamber) and X-ray diagnostic systems.

### CARRING OUT THE INVENTION

### Terms and Definitions Used in the Application

The definition “stable states of a dense high-temperature plasma” denotes the states of hydrostatic equilibrium of a plasma, when the gas-dynamic pressure is counterbalanced by the pressure of a magnetic field or, in the present case, by the pressure of the emitted gravitational field.

The definition “a dense high-temperature plasma” denotes a plasma with the lower values of densities n_{C},nᵢ=(10²³−10²⁵)m⁻³ and temperatures T_{c,}Tᵢ=(10⁷−10⁸) K.

The definition “plasma parameters corresponding to gravitational emission of electrons” (with a banded emission spectrum) denotes parameters which are in the above-indicated range of pressures and temperatures.

The definition “locking of gravitational emission in plasma” denotes the state of gravitational emission in plasma, which takes place when its emission frequency and electron Langmuir frequency are equal. In the present case locking of the emission takes place for two reasons:

energy transfer along the spectrum into the long wavelength region as a result of cascade transitions into the long wavelength region with attaining emission frequency (10¹³−10¹⁴) with plasma Langmuir frequency equal to the electron one, this being the condition of locking gravitational emission in plasma;

quenching spontaneous gravitational emission of electrons from the ground energy levels by multielectron atoms, when the energy of an excited electron is transferred to an ion with corresponding energy levels, leading to its ionization.

The definition “amplification of gravitational emission” denotes amplification which takes place when the gravitational emission is locked, because, with the locking conditions having been fulfilled, the gravitational emission remains in plasma with sequential emission of the total energy of the gravitational field locked in the plasma.

For a better understanding of the invention, given below is a description of high-temperature plasma formations which take place in the proposed method, and a description of a method of forming their stable states as hydrostatic equilibrium states. The conditions of gravitational emission of electrons with a banded spectrum, the conditions of exciting gravitational emission in plasma, and locking and amplification owing to cascade transitions as claimed in the set of claims presented hereinbelow, are disclosed.

1. Gravitational Emission of Electrons with a Banded Spectrum As Emission of the Same Level With Electromagnetic Emission.

For a mathematical model of interest, which describes a banded spectrum of stationary states of electrons in the proper gravitational field, two aspects are of importance. First. In Einstein's field equations κ is a constant which relates the space-time geometrical properties with the distribution of physical matter, so that the origin of the equations is not connected with the numerical limitation of the κ value. Only the requirement of conformity with the Newtonian Classical Theory of Gravity leads to the small value κ=8πG/c⁴, where G, c are, respectively, the Newtonian gravitational constant and the velocity of light. Such requirement follows from the primary concept of the Einstein General Theory of Relativity (GR) as a relativistic generalization of the Newtonian Theory of Gravity. Second. The most general form of relativistic gravitation equations are equations with the Λ term. The limiting transition to weak fields leads to the equation

ΔΦ=−4πρG+Λc²,

where Φ is the field scalar potential, ρ is the source density. This circumstance, eventually, is crucial for neglecting the Λ term, because only in this case the GR is a generalization of the Classical Theory of Gravity. Therefore, the numerical values of κ=8πG/c⁴ and Λ=0 in the GR equations are not associated with the origin of the equations, but follow only from the conformity of the GR with the classical theory.

From the 70's onwards, it became obvious (Siravam C . and Sinha K., Phys. Rep. 51 (1979) 112) that in the quantum region the numerical value of G is not compatible with the principles of quantum mechanics. In a number of papers (Siravam C . and Sinha K., Phys. Rep. 51 (1979) 112) (including also Fisenko S. et al., Phys. Lett. A, 148,7,9 (1990) 405)) it was shown that in the quantum region the coupling constant K (K≈10⁴⁰ G) is acceptable. The essence of the problem of the generalization of relativistic equations on the quantum level was thus outlined: such generalization must match the numerical values of the gravity constants in the quantum and classical regions.

In the development of these results, as a micro-level approximation of Einstein's field equations, a model is proposed, based on the following assumption:

“The gravitational field within the region of localization of an elementary particle having a mass m₀ is characterized by the values of the gravity constant K and of the constant Λ that lead to the stationary states of the particle in its proper gravitational field, and the particle stationary states as such are the sources of the gravitational field with the Newtonian gravity constant G”.

Complexity of solving this problem compels us to employ a simpler approximation, namely: energy spectrum calculations in a relativistic fine-structure approximation. In this approximation the problem of the stationary states of an elementary source in the proper gravitational field will be reduced to solving the following equations:

$$\begin{matrix} {f}^{″} + ( \frac{{v}^{′} - {λ}^{′}}{2} + \frac{2}{r} ) {f}^{′} + {e}^{λ} ( {K}_{n}^{2} {e}^{- v} - {K}_{0}^{2} - \frac{l ( l + 1 )}{{r}^{2}} ) f = 0 & ( 1 ) \\ - {e}^{- λ} ( \frac{1}{{r}^{2}} - \frac{{λ}^{′}}{r} ) + \frac{1}{{r}^{2}} + Λ = β ( 2 l + 1 ) \{ {f}^{2} [ {e}^{- λ} {K}_{n}^{2} + {K}_{0}^{2} + \frac{l ( l + 1 )}{{r}^{2}} ] + {f}^{′2} {e}^{- λ} \} & ( 2 ) \\ - {e}^{- λ} ( \frac{1}{{r}^{2}} + \frac{{v}^{′}}{r} ) + \frac{1}{{r}^{2}} + Λ = β ( 2 l + 1 ) \{ {f}^{2} [ {K}_{0}^{2} - {K}_{n}^{2} {e}^{- v} + \frac{l ( l + 1 )}{{r}^{2}} ] - {e}^{λ} {f}^{′2} \} & ( 3 ) \\ {\{ - \frac{1}{2} ( {v}^{″} + {v}^{′2} ) - ( {v}^{′} + {λ}^{′} ) ( \frac{{v}^{′}}{4} + \frac{1}{r} ) + \frac{1}{{r}^{2}} ( 1 + {e}^{λ} ) \}}_{r = {r}_{n}} = 0 & ( 4 ) \\ f ( \sqrt{{Λ}^{- 1}} ) = 0 & ( 5 ) \\ f ( {r}_{n} ) = 0 & ( 6 ) \\ λ ( 0 ) = v ( 0 ) = 0 & ( 7 ) \\ {\int }_{0}^{{r}_{n}} {f}^{2} {r}^{2} d r = 1 & ( 8 )\end{matrix}$$

Equations (1)-(3) follow from equations (9)-(10)

$$\begin{matrix}\{ - {g}^{μ v} \frac{\partial }{\partial {x}_{μ}} \frac{\partial }{\partial {x}_{v}} + {g}^{μ v} {Γ}_{μ v}^{α} \frac{\partial }{\partial {x}_{α}} - {K}_{0}^{2} \} Ψ = 0 & ( 9 ) \\ {R}_{μ v} - \frac{1}{2} {g}_{μ v} R = - κ ( {T}_{μ v} - μ {g}_{μ v} ) , & ( 10 )\end{matrix}$$

after the substitution of Ψ in the form of

$$Ψ = {f}_{El} ( r ) {Y}_{lm} ( θ , ϕ ) exp ( \frac{- i Et}{ℏ} )$$

into them and specific computations in the central-symmetry field metric with the interval defined by the expression (Landau Lifshitz E. M., Field Theory, Moscow, Nauka Publishers, 1976)

dS²=c²e^{v}dt²−r²(dθ²+sin² θdφ²)−e^{λ} dr² (11)

The following notation is used above: ƒ_{El} is the radial wave function that describes the states with a definite energy E and the orbital moment l (hereafter the subscripts El are omitted), Yₗₘ(θ,φ) are spherical functions, K=Eₙ/c, K₀=cm₀/, β=(κ/4π)(/m₀).

Condition (4) defines r_{n,} whereas equations (10) through (7) are the boundary conditions and the normalization condition for the function ƒ , respectively. Condition (4) in the general case has the form R(K, rₙ)=R(G, rₙ). Neglecting the proper gravitational field with the constant G, we shall write down this condition as R(K, rₙ)=0 , to which equality (4) actually corresponds.

The right-hand sides of equations (2)-(3) are calculated basing on the general expression for the energy-momentum tensor of the complex scalar field:

T_{μv}=Ψ_{,μ}⁺Ψ_{,v}+Ψ_{,v}⁺Ψ_{,μ}−(Ψ_{,μ}⁺Ψ^{,μ}−K₀²Ψ⁺Ψ) (12)

The appropriate components T_{μv} are obtained by summation over the index τ with application of characteristic identities for spherical functions (Warshalovich D. A. et al., Quantum Theory of Angular Momentum, Leningrad, Nauka Publishers, 1975 (in Russian)) after the substitution of

$$Ψ = f ( r ) {Y}_{lm} ( θ , ϕ ) exp ( \frac{- i Et}{ℏ} )$$

into (12).

Solution of equations (1)-(8) gives the following results:

a) With the numeric values K≈5.1×10³¹ Nm² kg⁻² and Λ=4.4×10²⁹ m⁻² there is a spectrum of steady states of the electron in proper gravitational field (0.511 MeV . . . 0.681 MeV). The basic state is the observed electron rest energy 0.511 MeV (FIG. 2).

b) These steady states are the sources of the gravitational field with the G constant.

c) The transitions to stationary states of the electron in proper gravitational field cause gravitational emission, which is characterized by constant K, i e. gravitational emission is an emission of the same level as electromagnetic (electric charge e, gravitational charge m\sqrt{K}). In this respect there is no point in saying that gravitational effects in the quantum area are characterized by the G constant, as this constant belongs only to the macroscopic area and cannot be transferred to the quantum level (which is also evident from the negative results of registration of gravitational waves with the G constant, they do not exist).

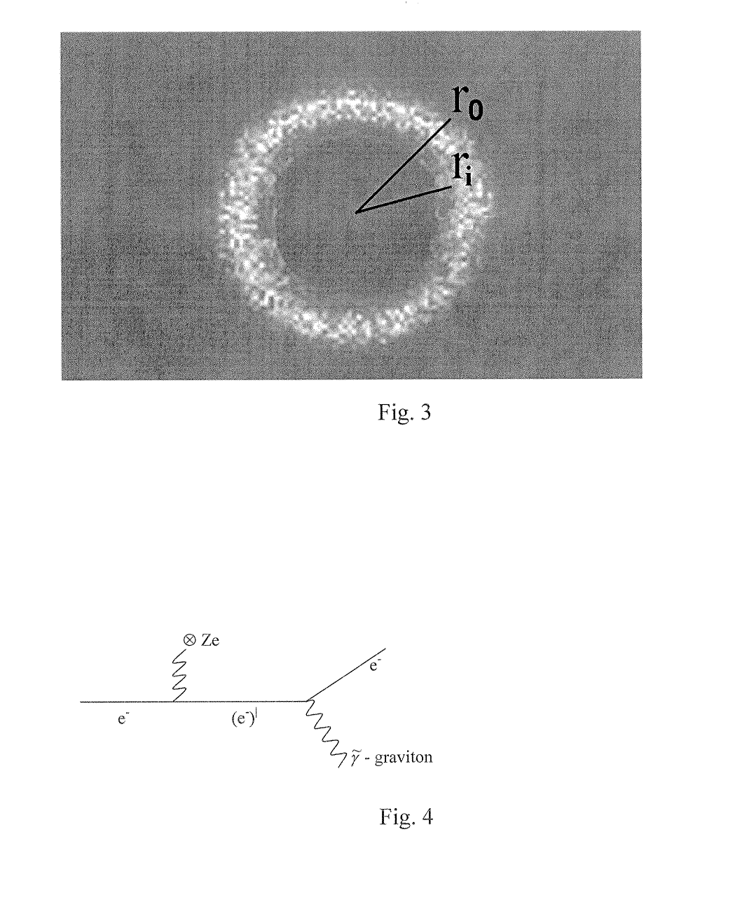

Existence of such numerical value Λ denotes a phenomenon having a deep physical sense: introduction into density of the Lagrange function of a constant member independent on a state of the field. This means that the time-space has an inherent curving which is connected with neither the matter nor the gravitational waves. The distance at which the gravitational field with the constant K is localized is less than the Compton wavelength, and for the electron, for example, this value is of the order of its classical radius. At distances larger than this one, the gravitational field is characterized by the constant G, i.e., correct transition to Classical GR holds (see FIG. 3).

There is certain analytic interest in β-decay processes with asymmetry of emitted electrons (Wu Z. S., Moshkovsky S. A., β-Decay, Atomizdat, Moscow (1970)), due to (as it is supposed to be) parity violation in weak interactions. β-asymmetry in angular distribution of electrons was registered for the first time during experiments with polarized nucleuses ₂₇Co^{60,} β-spectrum of which is characterized by energies of MeV. If in the process of β-decay exited electrons are born, then along with decay scheme

n→p+e⁻+\tilde{v} (13)

there will be also decay scheme

n→p+(e*)⁻+\tilde{v}→e⁻+\tilde{γ}+\tilde{v} (14)

where \tilde{γ}is a graviton.

Decay (14) is energetically limited by energy values of 1 MeV order (in rough approximation), taking into consideration that the difference between lower excitation level of electron's energy (in own gravitational field) and general <100 keV and the very character β-spectrum. Consequently, _{27Co}⁶⁰ nucleuses decay can proceed with equal probability as it is described in scheme (13) or in scheme (14). For the light nucleuses, such as ₁H³ β-decay can only proceed as it is described in scheme (13), At the same time, emission of graviton by electron in magnetic field can be exactly the reason for β-asymmetry in angular distribution of electrons. If so, then the phenomenon of β-asymmetry will not be observed in light β-radioactive nucleuses. This would mean that β-asymmetry in angular distribution of electrons, which is interpreted as parity violation, is the result of electron's gravitational emission, which should be manifested in existence of lower border β-decay, as that's where β-asymmetry appears to be.

Using Kerr-Newman metric for estimation of the numerical value of K one can obtain the formula (Fisenko S. et all, Phys. Lett. A, 148,8,9 (1990) 405)

$$K = \frac{{r}_{0}^{2}}{( \frac{{mcr}_{0}^{2}}{L} - \frac{L}{mc} ) ( \frac{m}{{r}_{0} {c}^{2}} - \frac{{e}^{2}}{{r}_{0}^{2} {c}^{4}} )} \qquad ( 15 )$$

where r_{0,}m, e, L are classical electron radius, mass, charge, orbital momentum respectively, and c is the speed of light.

Despite the fact that we used external metric and orbital momentum in deriving the formula (15), its use is legitimate for the orbital momentum of a particle in internal metric equal to the electron spin by an order of magnitude. The estimation of K from the formula (15) using the numerical values of the abovementioned arguments agrees with the estimation that stands in correspondence with numerical values of electron energy spectrum in proper gravitational field. This may suggest that the physical nature of spin is possibly such that these are just values of the orbital momentum of a particle in proper gravitational field (see FIG. 3).

2. Gravitational Emission in the Dense High-Temperature Plasma.

2.1. Initiation of Gravitational Emission in Plasma.

For the above-mentioned transition energies for stationary states in its own gravitational field and the energy level widths, the only object, in which gravitational emission as a mass phenomenon can be implemented, is a dense high-temperature plasma, which arises from the following estimations.

Using Born approximation for emission cross-section, the expression for electromagnetic radiation energy of a volume unit per unit of time can be represented as:

$${Q}_{e} = \frac{32}{3} \frac{{z}^{2} {r}_{0}^{2}}{137} {mc}^{2} {n}_{e} {n}_{i} \frac{\sqrt{2 k} {T}_{e}}{π m} = 0.17 \times {10}^{- 39} {z}^{2} {n}_{e} {n}_{i} \sqrt{{T}_{e}} , \qquad ( 16 )$$

where Tₑ, k, nₑ, m, z, r₀—electron temperature, the Boltzmann constant, concentrations of ionic and electronic components, electron mass, serial number of an electron component, and electron classical radius, correspondingly.

Substituting r₀ with r_{g}=2K m/c² (which corresponds to replacing electric charge e with a gravitational charge m√K), the following equation for gravitational emission can be used:

Q_{g}=0,16Qₑ (17)

It follows from (16) that in a dense high-temperature plasma with nₑ=nᵢ=10²³ m⁻³,Tₑ=107 K, the specific electromagnetic emission power is ≈0.53×10¹⁰ J/m³, and the value of the specific gravitational emission power is 0.86×10⁹ J/m³. These plasma parameter values, probably, could be considered as approximate threshold values of gravitational emission measurable level, since relative fraction of electrons, energy of which is approximately equal to transition energy level in its own gravitational field, with Tₑ decrease decays by Maxwell distribution exponent.

2.2. Amplification of Gravitational Emission in Plasma.

For numerical values of plasma parameters Tₑ=Tᵢ=(10⁷−10⁸)K, nₑ=nᵢ=(10²³−10²⁵)m⁻³ electromagnetic emission spectrum will not change significantly with Compton electron scattering effect, and the emission itself is a source of high-temperature plasma radiation losses. This continuous frequency range is about 10¹⁸ to 10²⁰ s^{-1,} whereas plasma frequency for the above-mentioned plasma parameters is (10¹³⁻10¹⁴)c¹, or 0.1 eV of emitted quantum energy.

The principle difference between gravitational emission and deceleration electromagnetic emission is a fact that gravitational emission line spectrum corresponds to steady state spectrum of electron in its own gravitational field.

The presence of cascade transitions from the upper to the lower levels will result in electrons, excited in energy region more than 100 keV, will be emitted mainly in eV-region, i.e., energy transfer by the spectrum to the low-frequency region will take place. Such energy transfer mechanism can take place only when spontaneous radiation quenching of the lower energy levels of an electron in its own gravitational field is performed, which prevents emission with quantum energy in keV-region. A detailed description of the energy transfer mechanism by the spectrum hereinafter will give its exact numerical characteristics. However, we can undoubtedly confirm the fact of its existence, caused by the linear character of the gravitational emission spectrum. A low-frequency nature of the gravitational emission spectrum of the gravitational radiation will result in its strengthening in plasma due to fulfillment of the locking condition ω_{g}≦0.5√10³n_{e.}

In terms of practical implementation of states of the high-temperature plasma, compressed by the emitted gravitational field, two things are important.

(1). The plasma must be at least a two-component, with an addition of multiply charged ions to hydrogen, necessary for quenching spontaneous radiation of electrons of the lower energy levels in their own gravitational field. To accomplish this, we must have ions with electron energy levels close to the energy levels of the excited free electrons. Suppression of the lower excited states of electrons would be particularly effective if there is a resonance between the excited electron energy and excitation energy of electron in ion (in the limiting, the most favorable case—the ionization energy). Increase of z also results in build-up of the specific gravitational emission power, so that when condition ω_{g} ≦0.5√110³nₑ is fulfilled, equality of gas-kinetic pressure and emission pressure

k(nₑ Tₑ+nᵢTᵢ)=0.16(0.17 10⁻³⁹ z² nₑ nᵢ √Tₑ)Δt (18)

will be observed, provided that Δt=(10⁻⁶−10⁻⁷) seconds for reasonable parameter values of the compressed plasma nₑ=(1+a)nᵢ=(10²⁵−10²⁶)m⁻³,a>2, Tₑ26 Tᵢ=10⁸K and z>10.

(2). The necessity of plasma ejection from the magnetic field region with speculative parameters like nₑ=(10²³−10²⁴)M⁻³, Tₑ=(10⁷−10⁸) K, with the subsequent energy downloading from the magnetic field region.

2.3 Cumulative Action to Obtain Stable States of a Dense High-Temperature Plasma

Formation and dispersal of binary plasma with multicharged ions with a driving magnetic field in a pulsewise high-current discharge.
Injection of binary plasma from the driving magnetic field region.

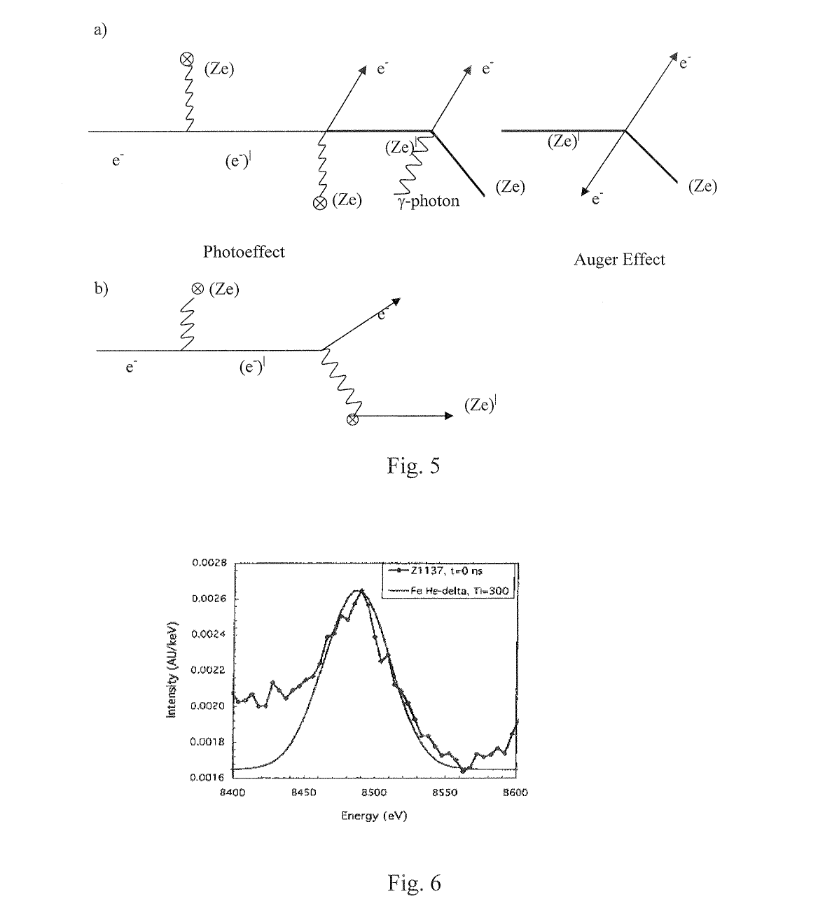

Initiation of the electron stationary states in its own gravitational field, ranging up to 171 keV with subsequent emission (FIG. 4), in conditions of quenching the lower excited energy levels of electrons at the heavy component ion electron shells (see FIG. 5, including quenching of the excited electron states directly at the nuclei of the small atomic numbers like carbon), while braking down plasma bunch injected from the driving magnetic field region. As for the cascade transitions from the upper energy levels, they are implementing the process of gravitational energy transfer to the long-wave region.

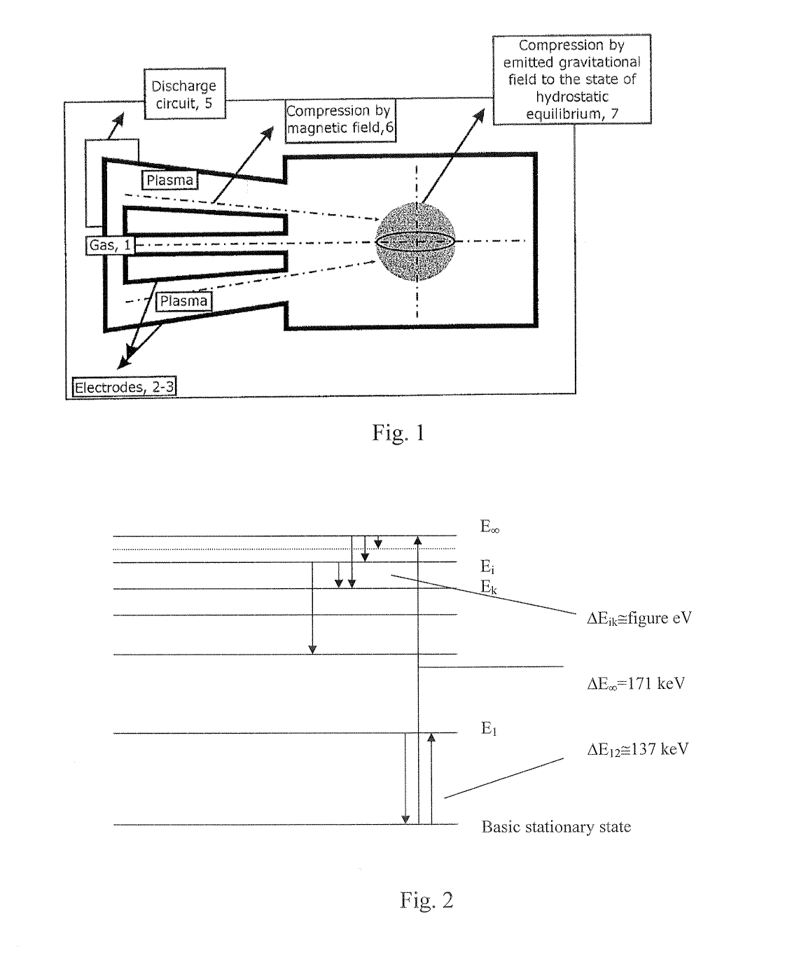

The claimed method is realized in the following manner (see the FIG. 1): through a quick-acting valve 1 a two-component gas (hydrogen+a multielectron gas) is supplied into a gap between coaxial conical electrodes 2, 3, to which voltage is fed through a discharge circuit 5. A discharge creating a magnetic field flows between the electrodes. Under the pressure of the arising amperage, plasma is accelerated along the channel. At the outlet in a region 7 the flow converges to the axis, where a region of compression with high density and temperature originates. The formation of the region of compression 7 is favored by efflux currents which flow in the outgoing plasma jet. With the voltage fed to the anode (20-40) kV and the starting pressure of the working gas (0.5-0.8) mm Hg, and when the current in the forming discharge reaches about 1 MA in the region of compression, the values of the plasma parameters nₑn, ᵢ=(10²³−10²⁵) m⁻³ and of the temperatures Tₑ, Tᵢ₌(10⁷−10⁸) K, necessary for the excitation of the gravitational field of the plasma, will be reached. The presence of the ions of multielectron atoms in the composition of the working gas, which lead to quenching the gravitational emission from the ground energy levels of the electrons, and cascade transitions along the levels of the electron stationary states in the own gravitational field will lead to the transformation of the high-frequency emission spectrum into the lows-frequency one with frequencies corresponding to locking and amplification of the plasma emission. Simultaneously the density and temperature of the plasma will grow owing to its pulsed injection. Therefore, sub sequent compression of the plasmas after its injection from the magnetic field region to the state of hydrostatic equilibrium (formation of the stable stat of the dense high-temperature plasma) takes place owing to the excitation, locking and compression of the plasma by the radiated gravitational field, with the attainment of the plasma parameters nₑ, nᵢ=(10²⁵−10²⁶) m⁻³ and Tₑ, Tᵢ =10⁸ K.

3. Experimental Evidence

3.1. Spectral Lines Widening of the Radiation of Multiple-Charge Ions

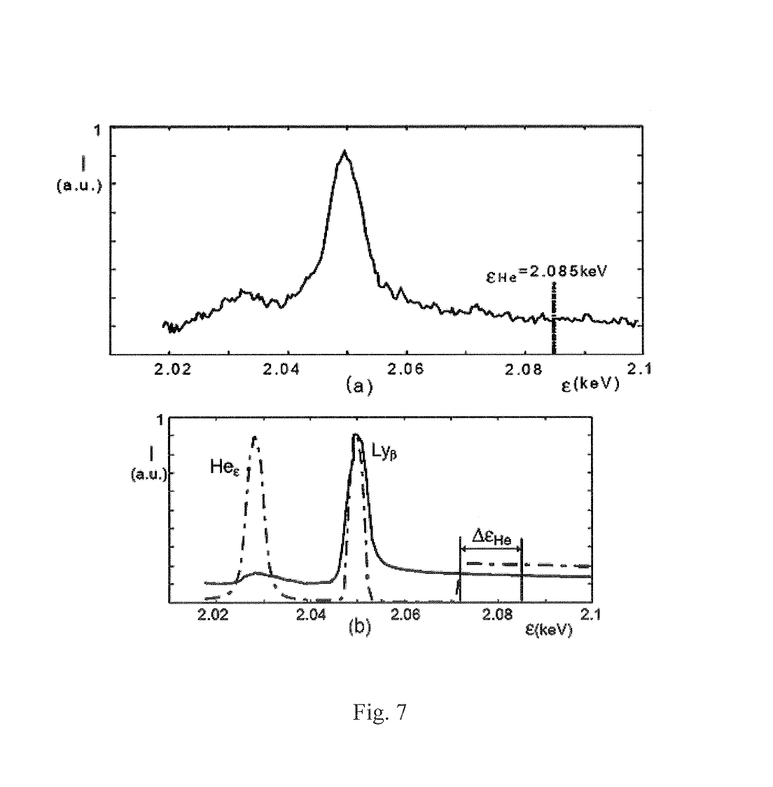

FIGS. 6, 7 show characteristic parts of micropinch soft X-ray radiation spectrum. Micropinch spectrum line widening does not correspond to existing electromagnetic conceptions but corresponds to such plasma thermodynamic states which can only be obtained with the help of compression by gravitational field , radiation flashes of which takes place during plasma thermalization in a discharge local space. Such statement is based on the comparison of experimental and expected parts of the spectrum shown in FIG. 7(a, b). Adjustment of the expected spectrum portion to the experimental one was made by selecting average values of density ρ, electron temperature Te and velocity gradient U of the substance hydrodynamic motion.

As a mechanism of spectrum lines widening, a Doppler, radiation and impact widening were considered. Such adjustment according to said widening mechanisms does not lead to complete reproduction of the registered part of the micropinch radiation spectrum. This is the evidence (under the condition of independent conformation of the macroscopic parameters adjustment) of additional widening mechanism existence due to electron excited states and corresponding gravitational radiation spectrum part already not having clearly expressed lines because of energy transfer in the spectrum to the long-wave area.

That is to say that the additional mechanism of spectral lines widening of the characteristic electromagnetic radiation of multiple-charge ions (in the conditions of plasma compression by radiated gravitational field) is the only and unequivocal way of quenching electrons excited states at the radiating energy levels of ions and exciting these levels by gravitational radiation at resonance frequencies. Such increase in probability of ion transitions in other states results in additional spectral lines widening of the characteristic radiation. The reason for quick degradation of micropinches in various pulse high-currency discharges with multiple-charge ions is also clear. There is only partial thermolization of accelerated plasma with the power of gravitational radiation not sufficient for maintaining steady states .

3.2. Emission Spectra of Electron Beams on Foil for Various Materials and Their Energy Spectra after Passing the Foil

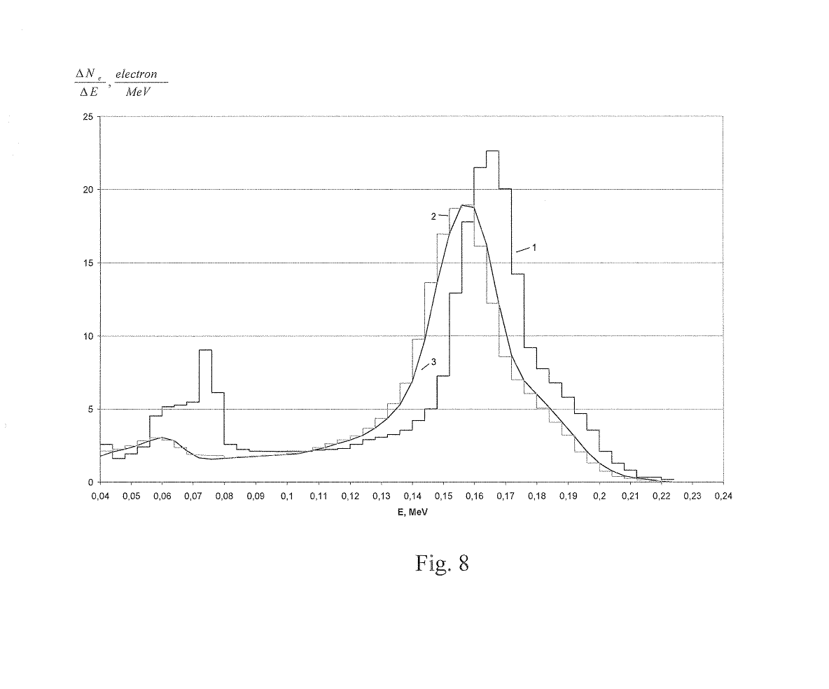

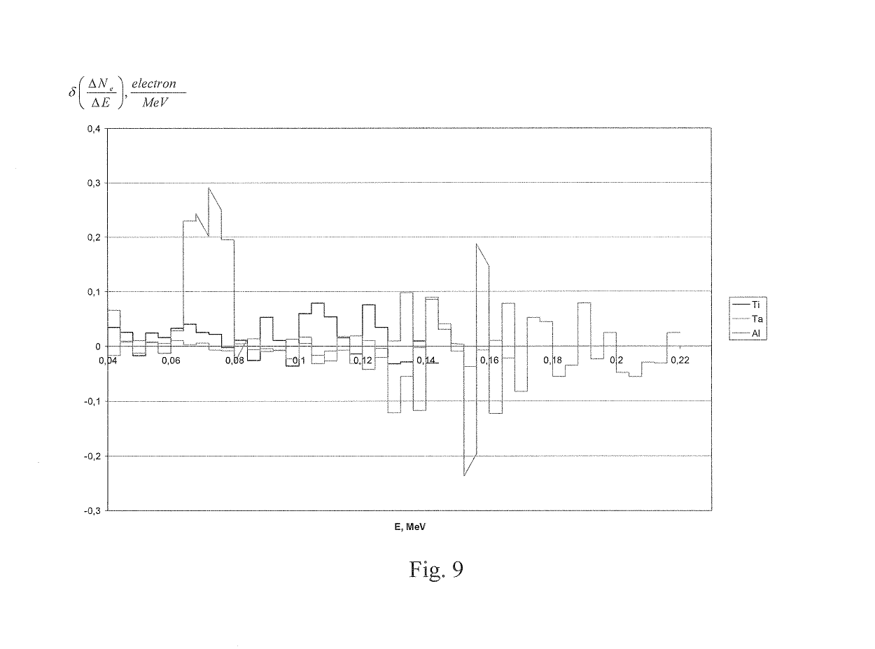

This data, of course, should be completed both by electron gravitational emission lines and by stationary states energy spectrum of an electron in its own gravitational field. Previously, the following measurements were carried out. Fig.8 shows the energy spectra of electron beams in a pulsed accelerator, measured with a semicircular magnetic spectrometer. Presence of two peaks on energy spectra is associated with an operating mode feature of the pulsed electron accelerator, i.e., the presence of the secondary peak of lower power. This leads to the second (low-energy) peak in energy spectral distribution. Measurement error in the middle and soft part of the spectrum does not exceed ±2%. The energy spectrum of electrons passing through the anode mesh, and spectra of electrons passing through the foil attached above the mesh anode of the accelerator, were measured with a magnetic spectrometer. This data, as well as a calculated range, are shown in FIG. 8. Similar measurements were taken for Ti foil (foil thickness was 50 microns) and Ta foil (of 10 microns thickness). For Ti and Ta upper limits of measurements were 0.148 MeV and 0.168 MeV correspondingly; above these limits the measurement errors substantially increase (for the accelerator used). FIG. 9 shows the difference of normalized spectral densities of the theoretical and experimental spectra of electrons after passing through the Ti, Ta and Al foils. These data indicate the presence spectrum of energetic states of electrons in their own gravitational field, which are excited while passing through foil.

Emission spectra in this series of experiments were not measured, and the measurements should be performed with detectors of higher sensitivity with simultaneous measuring of emission spectra. Provided data is not sufficient for numerical identification of the energy state spectrum of the electrons in their own gravitational field, but the very existence of the spectrum, according to this data, is unquestionable.

3.3 Characteristic Radiation Spectra of Stars and Laboratory Plasma

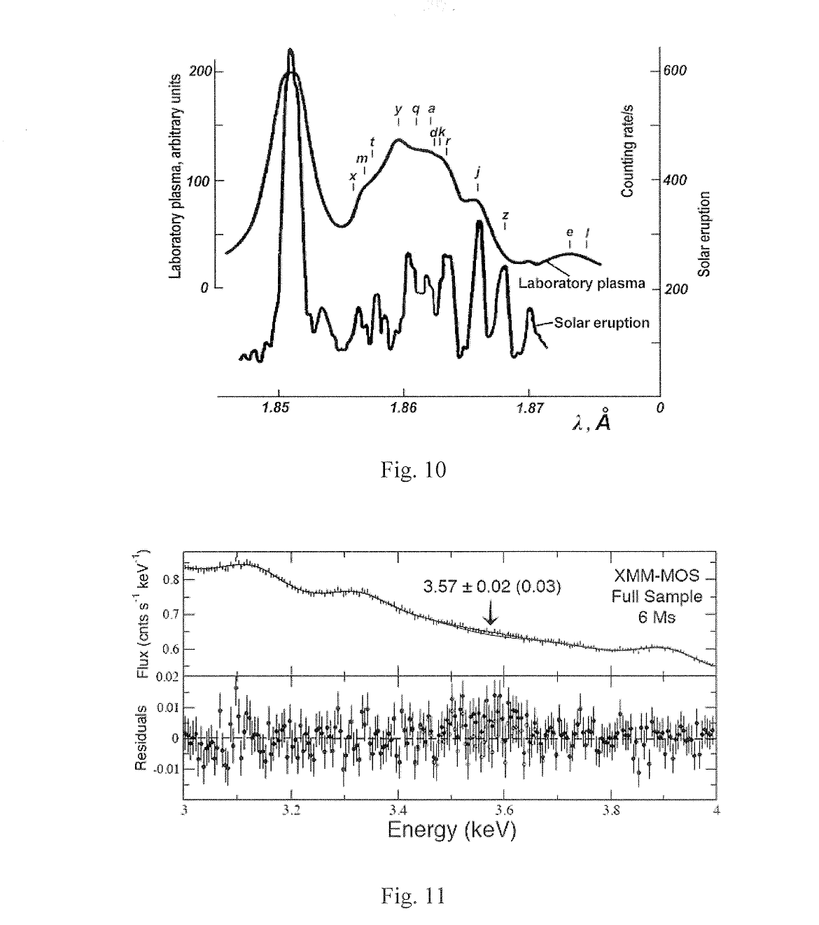

FIGS. 6, 7 show the characteristic parts of the spectrum of soft X-ray radiation of micropinches. Adjustment due to known mechanisms of broadening does not give full reproduction of broadening of the micropinch emission spectrum in the recorded portion. This indicates the presence of an additional mechanism of broadening the spectrum of the recorded portion of the characteristic radiation due to the contribution of the excited states of electrons in their gravitational field. FIG. 10 shows the spectra of the characteristic radiation of the laboratory plasma and spectra recorded during the flare on the Sun , which also show a significant difference in the width of the emission spectra. This difference takes place in the same frequency range, and it is due to the presence in the laboratory plasma of the micropinch region.

Two groups of researchers, independently of each other (E. Bulbul et al. Detection of An Unidentified Emission Line in the Stacked X-ray spectrum of Galaxy Clusters // e-print arXiv:1402.2301 [astro-ph.CO]. , A. Boyarsky, O. Ruchayskiy, D. lakubovskyi, J. Franse. An unidentified line in X-ray spectra of the Andromeda galaxy and Perseus galaxy cluster // e-print arXiv:1402.4119 [astro-ph. CO].) reported that in the X-ray spectra of galaxy clusters there is a new line of radiation with an energy of 3.57 keV. This radiation should go from hot intergalactic gas that fills the cluster of galaxies, but, unlike other identified emission lines, this cannot be explained by any atomic transition.

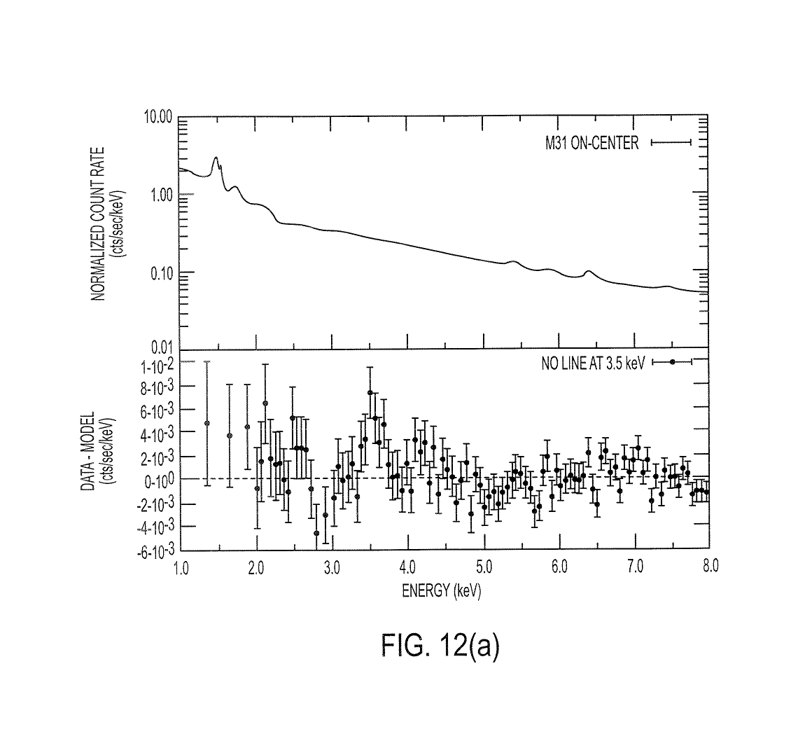

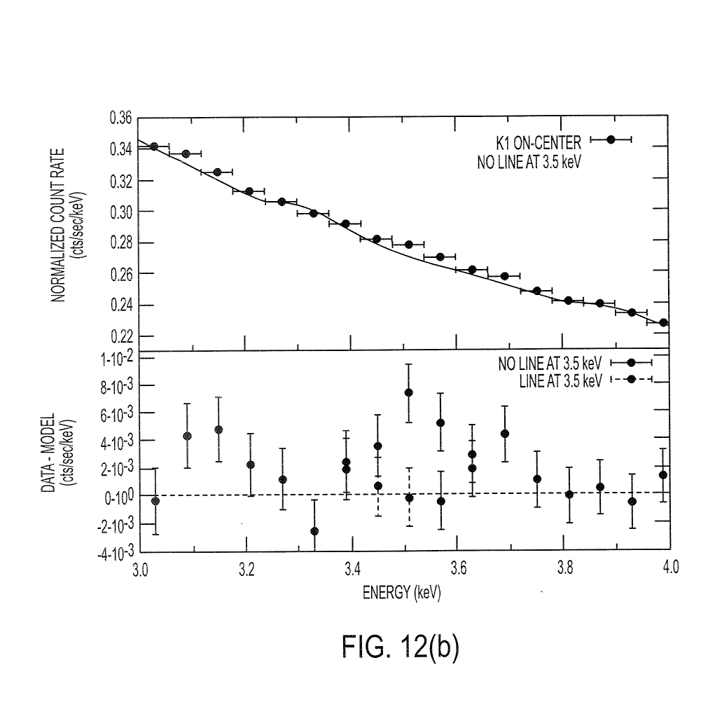

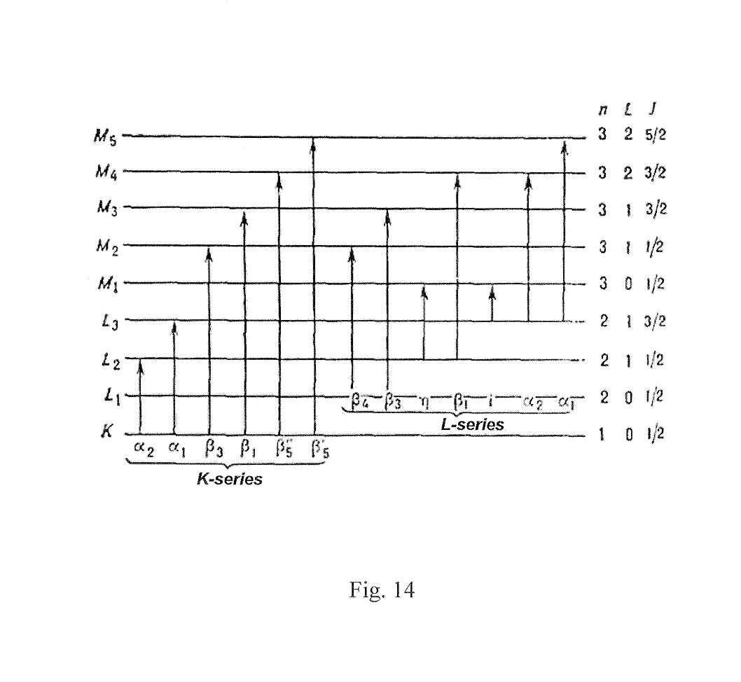

The results of these measurements are shown in FIG. 11 and FIG. 12. At the same time, the resonance spectra of stationary states of electrons in its gravitational field and the spectra of multiple-charge ions can produce not only the registered emission line, but also other lines of similar properties. The possibility of such situation clearly follows from the comparison of the electron energy spectra in its own gravitational field (FIG. 2), and K-, L- and M-levels of the atom energies and the major lines of the K- and L-series (FIG. 14).

We can expect the presence of such lines in detailed registration of the emission spectra of astrophysical objects in the energy range greater than 8 keV.

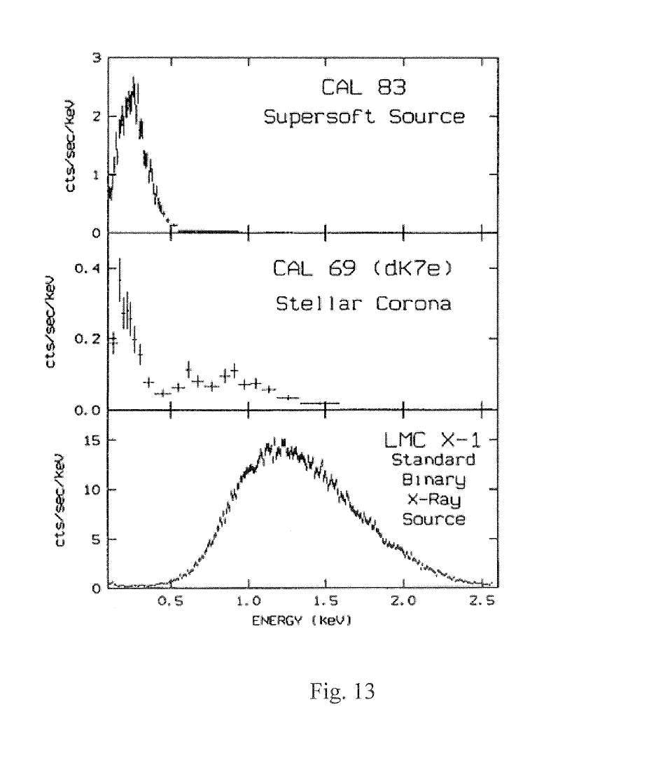

FIG. 13 shows the results of later measurements of the soft X-ray spectrum (Kahabka P. and van den Heuvel E. P. J., 1997, Ann. Rev. Astron. Astrophys., 35, 69, 1997).There is no new line in this spectrum, but the spectrum is clearly broadened, more than it would be consistent with known mechanisms of spectral broadening.

4. Composition and Working Conditions of the Experimental Installation Corresponding to the Invention Claims

The sequence of the operations is carried out in a two-sectional chamber of MAGO installation (developed at All-Russian Scientific Research Institute of Experimental Physics (Sarov)); the structure of the installation is most suitable for the claimed method of forming steady states of the dense high-temperature plasma) with magnetodynamic outflow of plasma and further conversion of the plasma bunch energy (in the process of quenching) in the plasma heat energy for securing both further plasma heating and exciting gravitational radiation and its transit into a long-wave part of the spectrum with consequent plasma compression in the condition of radiation blocking and increasing.

All current thermonuclear plasma generators are stationary, large-dimensioned plants (up to hundreds of meters). Their dimensions are determined by the density of energy stored in the electric power supply elements of the capacitor-based generators (not higher than 1 MJ/m³). This applies both to the installations with inertial plasma confinement (laser and electrical), and installations with magnetic plasma confinement (ITER). The most powerful laser installations (NIF in the United States and UFL-2M in RF) have laser radiation energy ˜2MJ per pulse; there are also electro-physical plants: plant Z in the USA (stored energy value of the capacitor battery is ˜15 MJ, delivered to Z-pinch usable energy ˜1-2 MJ) and BAIKAL plant being built in Russia, which is about an order of magnitude more powerful than Z plant.

Another characteristic feature of the existing inertial plasma confinement installations is the fact that the prospects of obtaining thermonuclear plasma ignition require deep bulk compression of fuel, more than 10⁴ times in volume. For such compression rates obtaining stable state of thermonuclear plasma for ignition is still an unresolved problem due to Rayleigh-Taylor instability growth. With the magnetic confinement (ITER) obtaining a positive thermonuclear energy output does not require deep compression, but due to the low density of fuel necessary to meet the Lawson criterion, plasma stability should be maintained during long period of time (seconds). So far this has not been achieved.

MAGO installation is operating in two steps. At the first step, a hot magnetized plasma with the temperature of thousands eV is formed. Subsequently, the plasma is compressed and its temperature rises. Due to initial heat-up to achieve a positive thermonuclear energy output, just moderate bulk compression (˜10²) is necessary, which, unlike of the conventional devices, easily can be obtained with the maintenance of plasma stability. Thermonuclear plasma density is more than six orders of magnitude higher than the ITER plasma density. Respectively, the time, required for thermonuclear energy output during plasma stability period, is less than 1 μs.

The MAGO chamber capacity of work with deuterium-tritium composition was tested experimentally. The obtained experimental data of plasma compression in MAGO chamber (O. M. Burenkov, Y. N. Dolin, P. V. Duday, V. I. Dudin, V. A. Ivanov, A. V. lvanovsky, G. V. Karpov, et al. New Configuration of Experiments for MAGO Program, XIV International Conference on Megagauss Magnetic Field Generation and Related Topics (Oct. 14-19, 2012), Maui, Havaii, USA, p. p. 95-99) prove that there is the fusion reaction ; however the holding time is not sufficient, there need to be longer holding time. The choice of such design as a design for a thermonuclear reactor is unequivocal since it is completely corresponds to the system of exciting and amplifying gravitational radiation when plasma is therrnolized after outflow from the nozzle, and required additional compression actually takes place when the working plasma composition is changed (many-electron ions) and current-voltage characteristic of the charge changes correspondingly. The simplicity of the MAGO chamber technical structure is even more clearly shown by the possibility to use as the generator of electrical load such devices as a capacitors battery or an autonomous magnetic explosion generator (VMG) with all consequences of practical use of such thermonuclear reactor.

One skilled in the art will understand that various modifications and variants of embodying the invention are possible, all of them being comprised in the scope of the Applicant's claims, reflected in the set of claims presented hereinbelow.

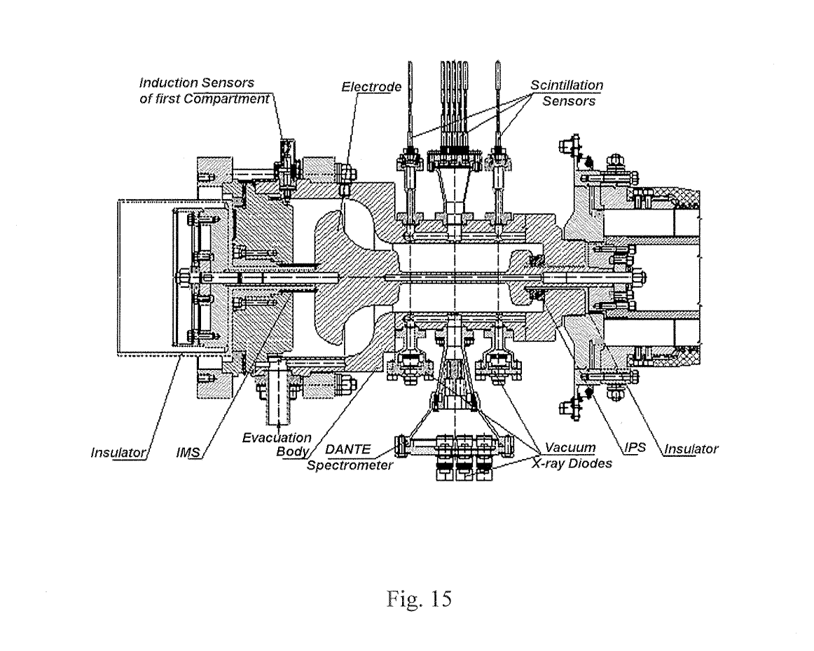

A variant of the experimental installation with MAGO chamber for forming a stable state of a dense high-temperature plasma (with addition of multielectron atoms in accordance with the invention claims) is shown in FIG. 15.

Of interest, there are two modes of the installation operations depending on the work gas composition .

1. A composition with hydrogen and (for examp)e) xenon providing for achieving steady states of plasma with consequent realization of thermonuclear reactions for compositions of (d+t) +multi-charge atoms type.

Fusion Eaction Creating Helium Generates Neutrons

₁²H+₁³H→₂⁴He+₀¹n+17.6 MeV

and was embodied in the well-known Teller-Ulam design with radiation implosion.

An application of the compression-by-the-radiated-gravitational-field design, unlike the Teller-Ulam design, is not limited by the minimum discharge power attendant to the usage of a plutonium nucleus. This means both a feasibility of this fast fusion reaction a steady mode for low-power discharges, and (under certain conditions) a feasibility of explosive energy release without the use of fissile elements (like plutonium and uranium) for high-power discharges.

2. A composition with hydrogen and carbon providing thermonuclear reactions of carbon cycle in plasma steady state mode, including energy pick-up in the form of electromagnetic radiation energy CNO cycle is a set of fusion reactions resulting in conversion of hydrogen into helium using carbon as a catalyst.

In a compact notation, this cycle would be written as

¹²C(p,γ)¹³N(e⁺ν)¹³C(p,γ)¹⁴N(p,γ)¹⁵O(e⁺ν)¹⁵N(p,α)¹²C

The ¹⁵N(p,α)¹²C reaction rounds the cycle out. The net result is that four protons turn into an α-particle—⁴He nucleus with no neutrons among end products of the cycle. Producing one helium nucleus releases 25 MeV, the produced neutrinos carry away about 5% more of that energy. A peculiarity of such fusion reaction cycle is that it occurs in natural conditions of astrophysical objects. At the same time, e. g. the design features of MAGO facility allow achieving such a volt-ampere characteristics (VAC) mode that boosts the speed of carbon cycle reactions. An implementation of carbon cycle in the gravitational compression design may possibly become a basic design to form steady states of the thermonuclear plasma, bearing in mind low abundance of hydrogen and lithium isotopes that react with no neutrons being produced either.

1. A method of forming stable states of a dense high-temperature plasma, comprising the following steps:
a) generation of a dense high-temperature plasma from a working gas composition, including hydrogen isotopes and multielectron atoms, by means of the pulsewise high current discharges;
b) injection of the plasma from the area of a magnetic field with parameters corresponding to conditions of gravitational emission of electrons with a banded energy spectrum, which provides energy transfer along the spectrum, performed by cascade transition into the long wavelength region of eV-energy to the state of locking and amplification of the gravitational emission in the plasma and simultaneous compression to the states of hydrostatic equilibrium, wherein multielectron atoms are used for quenching spontaneous gravitational emission from the lower energy levels of the keV-region electron in its own gravitational field.

2. The method according to claim 1, wherein to obtain steady states of a dense high-temperature plasma, hydrogen and multielectron atoms, including hydrogen and carbon, are used both in order to realize carbon cycle nuclear fusion reactions, where carbon and intermediate carbon cycle products (nitrogen and oxygen) are being used for quenching gravitational emission spectra of keV-energies, and as the fusion reaction catalysts.
